(19) United States
(12) Patent Application Publication
(10) Pub. No.: US 2010/0223549 A1
(43) Pub. Date: Sep. 2, 2010

(54) SYSTEM AND METHOD FOR CONTROLLING ENTERTAINMENT DEVICES USING A DISPLAY

(76) Inventor: Greg Edwards, Austin, TX (US)

Correspondence Address: AT&T Legal Department - Roebuck;Attn: Patent Docketing, One AT&T Way,, Room 2A-207, Bedminster, NJ, 07921, US

(21) Appl. No.: 12/394,186

(22) Filed: Feb. 27, 2009

(51) Int. Cl. G06F 3/00; G10L 11/00; G06F 3/048; G06F 17/30

(52) U.S. Cl. 715/708; 704/270.1; 715/839; 704/E11.001; 707/E17.044

(57) ABSTRACT

A method is disclosed for controlling an electronic device, the method including but not limited to electronically identifying a first remote control device for a first electronic device at a multimedia processor end user device; accessing specification data for the first remote control device for determining functions available on the first remote control device; displaying an image of a second remote control on the display for the multimedia processor end user device; mapping a set of remote control functions available on the first remote control device to a set of function keys on the second remote control display; and highlighting a function key on the image of the second remote control to which a function performed by a selected function key on the first remote control is mapped. A system and computer program product are disclosed for performing the method.

### FIELD OF THE DISCLOSURE

The present disclosure relates to the field of remote controls for television.

### BACKGROUND OF THE DISCLOSURE

Typically users have a separate remote control device for all televisions, digital video players and recorders and other consumer electronic devices in the home. Due the plethora of different remote controls, manufacturers and suppliers have produced universal remote controls that take the place of the various remote controls and control all the different consumer electronic devices from the single universal remote control. Users, however, have historically had difficulty adapting the existing physical universal remote controllers for home use in control all the various consumer electronic devices.

### BRIEF DESCRIPTION OF THE DRAWINGS

FIG. 1 depicts an illustrative embodiment of a universal remote control image displayed for configuration to perform functions of a particular remote control;

FIG. 2 depicts an illustrative embodiment of a universal remote control image displayed for configuration of function keys to perform functions of a particular remote control;

FIG. 4 depicts an illustrative embodiment of a reconfigured universal remote control displayed to perform functions of a particular remote control;

FIG. 5 depicts a data structure embedded in a computer readable medium that is used by a processor and method in an illustrative embodiment; and

FIG. 6 is an illustrative embodiment of a machine for performing functions disclosed in an illustrative embodiment.

### DETAILED DESCRIPTION

An illustrative embodiment provides an image of a universal remote control that can be used to control various electronic devices. The universal remote control is displayed on a multimedia processor end user device such as a television. An illustrative embodiment automatically maps functions of a particular remote control to the universal remote control. The specifications including the functions performed and assigned to various function keys on the particular remote control are retrieved from a data base and automatically programmed into the universal remote control. In a particular embodiment, an image of the specific remote control and an image of the universal remote control are displayed together. An end user can place a cursor over a selected function key on the particular remote control and a key is highlighted on the universal remote control to which the function of the selected key has been mapped. In another embodiment, an instructional message is presented audibly and/or visually explaining the use and function of the selected key on the particular remote control and the highlighted function key on the universal remote control. In another embodiment, an end user is presented with a graphical tool kit to redesign the appearance and operation of universal remote control image.

In another illustrative embodiment, a method is disclosed for controlling an electronic device, the method including but not limited to electronically identifying a first remote control device for a first electronic device at a multimedia processor end user device; accessing specification data for the first remote control device for determining functions available on the first remote control device; displaying an image of a second remote control on a display for the multimedia processor end user device; mapping a set of remote control functions available on the first remote control device to a set of function keys on the image of the second remote control display; accepting input data indicating a selected function key on the first remote control; and highlighting a function key on the image of the second remote control to which a function performed by a selected function key on the first remote control is mapped.

In another embodiment, the method further includes but is not limited to displaying an image of the first remote control device on the display for a multimedia processor end user device. In another embodiment of the method the selected function key on the first remote control is selected by an act selected from the group consisting of detecting placement of a cursor over the selected function key on the image displayed of the first remote control device and detecting actuation of the selected function key on the first remote control device. In another embodiment, the method further includes but is not limited to presenting an instructional message explaining a function performed by the selected function key on the first remote control device. In another embodiment, the method further includes but is not limited to accepting input data from the multimedia processor end user device indicating a change in the image of the second remote control on the display; and changing the image of the second remote control on the display in accordance with the input data indicating the change.

In another embodiment of the method the change in the image further includes but is not limited to a change selected from the group consisting of a change in the appearance of a selected function key, a change in the operation and appearance of a selected function key and a change in the appearance of the image of the second remote control. In another embodiment, the method further includes but is not limited to assigning a name to the changed image of the second remote control for storage access in the data base by end users. In another embodiment, the method further includes but is not limited to displaying a graphical toolkit for designing a remote control appearance, wherein the input from the multimedia processor end user device is accepted by the graphical tool kit indicating the change in the image of the second remote control. In another embodiment, the method the graphical tool kit presents a plurality of appearances of function keys selected from the group consisting of slider bars, rotating radio knobs, joy sticks and push buttons, wherein each of the plurality of appearances operate differently from each other.

In another embodiment of the method the first remote control is identified by a camera and image recognition processor on the multimedia processor end user device. In another embodiment of the method the instruction message further includes but is not limited to an act selected from the group consisting of audibly announcing the instructional message on a sound reproduction device in data communication with the multimedia processor end user device and announcing the instructional message on the display for the multimedia processor end user device. In another embodiment, the method further includes but is not limited to controlling the first electronic device from the function keys displayed on the image of the second remote control.

In another illustrative embodiment, a computer readable medium containing an embedded computer program for controlling an electronic device, the computer program comprising instructions to electronically identify a first remote control device for a first electronic device at a multimedia processor end user device; instructions to access specification data for the first remote control device for determining functions available on the first remote control device; instructions to display an image of a second remote control on a display for the multimedia processor end user device; instructions to map a set of remote control functions available on the first remote control device to a set of function keys on the image of the second remote control display; instructions to highlight a function key on the image of the second remote control to which a function performed by a selected function key on the first remote control is mapped; and instructions to display an image of the first remote control device on the display for the multimedia processor end user device.

In another embodiment of the medium the selected function key on the first remote control is selected by an act selected from the group consisting of detecting the presence of a cursor over the selected function key on the image displayed of the first remote control device and detecting an actuation of the selected function key on the first remote control device. In another embodiment of the medium, the computer program further includes but is not limited to instructions to accept input data from the multimedia processor end user device indicating a change in the image of the highlighted function key on the second remote control on the display; and instructions to change the appearance of the image of the highlighted function key on the second remote control on the display in accordance with the input.

In another embodiment of the medium, the computer program further includes but is not limited to instructions receive data indicating a selection of a plurality of remote control devices displayed on the multimedia processor end user device display. In another embodiment of the medium, the computer program further includes but is not limited to instructions to control the first electronic device from the function keys displayed on the image of the second remote control.

In another illustrative embodiment, a system is disclosed for controlling an electronic device, the system including but not limited to a computer readable medium; a multimedia processor in data communication with the computer readable medium; an identifying component to receive data to electronically identify a first remote control device for a first electronic device at a multimedia processor end user device; a data base component to access specification data for the first remote control device for determining functions available on the first remote control device; a display component for the multimedia processor to present an image of a second remote control; a mapping component to assign a set of remote control functions available on the first remote control device to a set of function keys on the image of the second remote control; and a highlight component to visually enhance a function key on the image of the second remote control to which a function performed by a selected function key on the first remote control is mapped.

In another embodiment of the system, the system further includes but is not limited to an input component to receive data indicating a selected function key on the first remote control wherein the data is selected from the group consisting of data indicating detection of a cursor placement over the selected function key on the image displayed of the first remote control device and data indicating actuation of the selected function key on the first remote control device. In another embodiment of the system, the system further includes but is not limited to a presentation component to present an instructional message explaining a function performed by a selected function key on the first remote control device. In another embodiment of the system, the system further includes but is not limited to a graphical tool kit component to accept an input from the multimedia processor end user device indicating a change in the image of the highlighted function key on the second remote control on the display and change the appearance of the image of the highlighted function key on the second remote control on the display in accordance with the input.

In another embodiment of the system, the system further includes but is not limited to a camera and image recognition processor on the multimedia processor end user device to identify the first remote control device at the In another embodiment of the system, the system further includes but is not limited to an output component to send a control signal to the first electronic device corresponding to a selected function key displayed on the image of the second remote control.

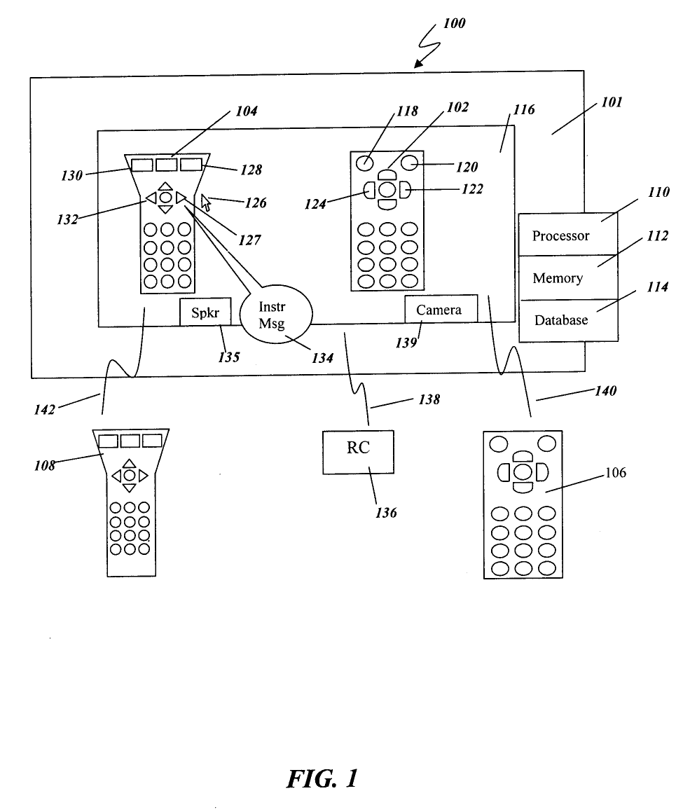

Turning now to FIG. 1, as shown in FIG. 1, in an illustrative embodiment 100 a first remote control device 106 is displayed as an image 102 on a display 116 for a multimedia processor end user device 101. The multimedia processor end user device includes but is not limited to a processor 110, memory in form of a computer readable medium 112 and a data base 114 including but not limited to data structures embedded in the computer medium. The first remote control device is identified by the multimedia processor end user device via camera 139 and image recognition software running in processor 110. In a particular illustrative embodiment, the image recognition software identifies the image of the first remote control device and looks up specifications for the first remote control in the data base 114.

In another particular embodiment the first remote is identified by a bar code on the remote control device. In another embodiment the remote control is identified by an electronic signal 140 containing identification data and sent from the first remote control device to the multimedia processor end user device. In a particular embodiment an image 104 of a second remote control device 108 is displayed on a display device associated with the multimedia processor end user device. In the present example, the second remote control device is a universal remote control to which functions of other particular remote control devices are mapped. In another embodiment the image of the first remote control is displayed along with the image of the second remote control device.

An end user remote control (RC) device 136 is used to send electronic signals 138 to the multimedia processor end user device to manipulate cursor 126 on the display screen for the multimedia processor end user device. In a particular embodiment, a multimedia processor end user device accepts a user input 138 from RC 136 to enter a mapping mode, entered by a sequenced manipulation of RC device 136 buttons or the RC device itself when equipped with an accelerometer. A function key 120 on the first remote control image 102 can be selected and mapped to a function key 128 on the second remote control image 104 by selecting the function key 128 after selecting the function key 120. In another embodiment, the functions of the first RC device are automatically mapped to the function keys of the second RC device 108 on the RC device 108 and its image 104. RC device 108 communicates via data signals 142 emitted from RC device 108. In another particular embodiment, a multimedia processor end user device accepts a user input from RC 136 to enter a mapping mode, entered by a sequenced manipulation of RC 136 buttons. In the mapping mode a function key 120 on the first remote control device 106 is selected and mapped to a selected function key 128 on the second remote control image 104. In another particular embodiment, a multimedia processor end user device accepts a user input from RC 136 to enter a mapping mode, entered by a sequenced manipulation of RC 136 buttons, a function key 120 on the first remote control device 106 can be selected and mapped to a function key 128 on the second remote control device 108. Additionally, the functions assigned to function keys 118, 124 and 122 on the first RC device can be automatically mapped or selected for user directed specific mapping according to end user input mapping the function keys to function keys on the second RC including but not limited to function keys 127, 130 and 132.

In another embodiment, when a particular function key is selected on the first remote control device image, the corresponding function key on the second remote control image is highlighted thereby indicating a mapping between the functionality implemented on the particular function key selected on the first remote control device image and highlighted function key on the image of the second remote control. In another embodiment, when a particular function key is selected on the first remote control device image, an informational message 134 is presented audibly via speaker 135 or visually on the multimedia processor end user device display 116 and the corresponding function key on the second remote control image is highlighted, such as by flashing, brightening or enlarging the function key on the display, thereby indicating a mapping between the functionality implemented on the particular function key selected on the first remote control device image and highlighted function key on the image of the second remote control.

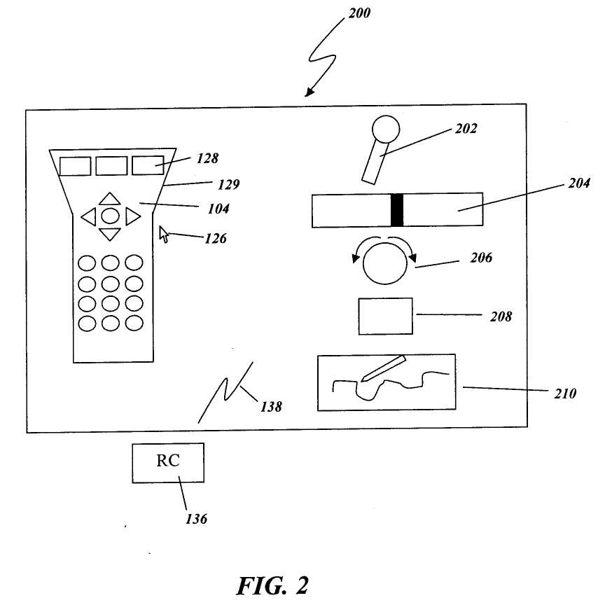

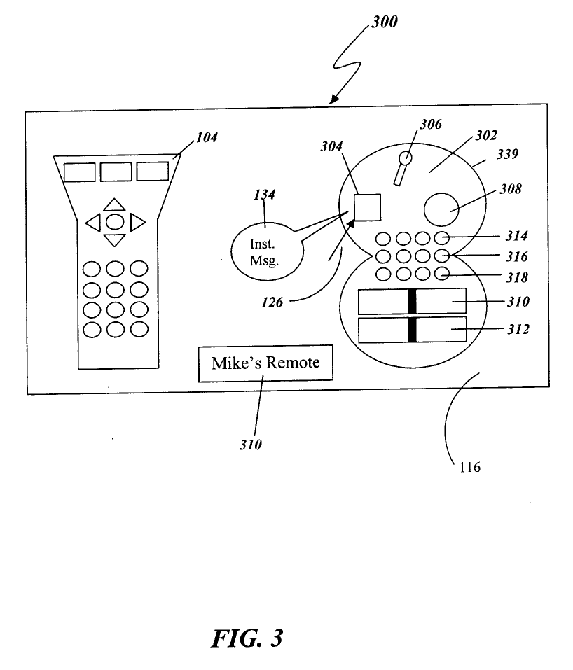

Turning now to FIG. 2, in a particular illustrative embodiment is depicted 200, the second remote control image can be configured to appear and function differently than the initial presentation of the image of the second remote control 104, which may be a default image for the second remote control 104. The function keys, such as function key 128 can be selected to be reconfigured as well as the shape 129 of the second remote control image. As shown in FIG. 2, a cursor 126 is used to select a function key or the shape 129 of the second remote control image and a graphical icon 202 to select a joy stick, 204 to select a slider bar, 206 to select a rotating radio knob and 210 to select draw mode to draw a new shape for a function key or a new shape for the second remote control device image.

As shown in FIG. 3, a graphical toolkit presents options for redesign the appearance and operation of the second remote control image 104. As shown in FIG. 3, a push button 128 on the image 104 of the second remote control can be selected by RC cursor 126 and reconfigured to function and appear as a joy stick 202, a slider bar 204, a rotating radio knob 206, a push button, or a free form drawing by selecting the drawing mode 210.

Turning now to FIG. 3, a reconfigured image 302 of second remote control image 104 is depicted after redesign by the graphical took kit depicted in FIG. 2. A function key on the redesigned remote control image 302 can be selected by the RC cursor 126 to have an informational message presented audibly or visually on the multimedia processor display. The reconfigured image 302 of the second remote control can be stored in a data structure in database 114 in a computer readable medium. Note that the old shape 129 for the second remote control image has been reconfigured into new shape 229. The reconfigured remote control image 302 of the second remote control can be named for a user 310 and stored in a data structure in database 114 in a computer readable medium for recall by the user as a custom remote control image for controlling an electronic device. The reconfigured remote control image 302 can be accessed in the data base by other end users for use in controlling electronic devices. New function key appearances 302, 304, 306, 308, 310, 312, 314, 315 and 318 have been selected for changing the appearance and operation of the function keys for the original second RC image 104. A slider bar replacing a rotating knob or push button also changes the operation of the function key. The informational message presented when a function key is selected by cursor 126 explains the current appearance, operation and function of the reconfigured image 302 for the second remote control.

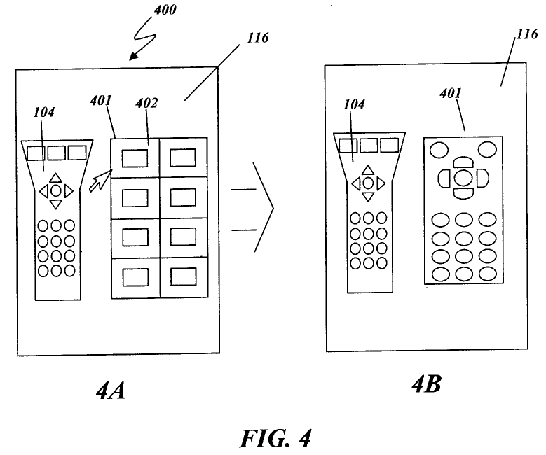

Turning now to FIG. 4, in another particular embodiment, a plurality of first remote control devices are presented in an image 402 on the multimedia processor end user device display. A particular one of the plurality of images 401 is selected in FIG. 4A for display along side the image of the second remote control image 104 as shown in FIG. 4B. The functions including information messages, mapping and reconfiguration shown in FIG. 1-3 and described herein can be performed on the images of the first and second remote controls shown in FIG. 4B.

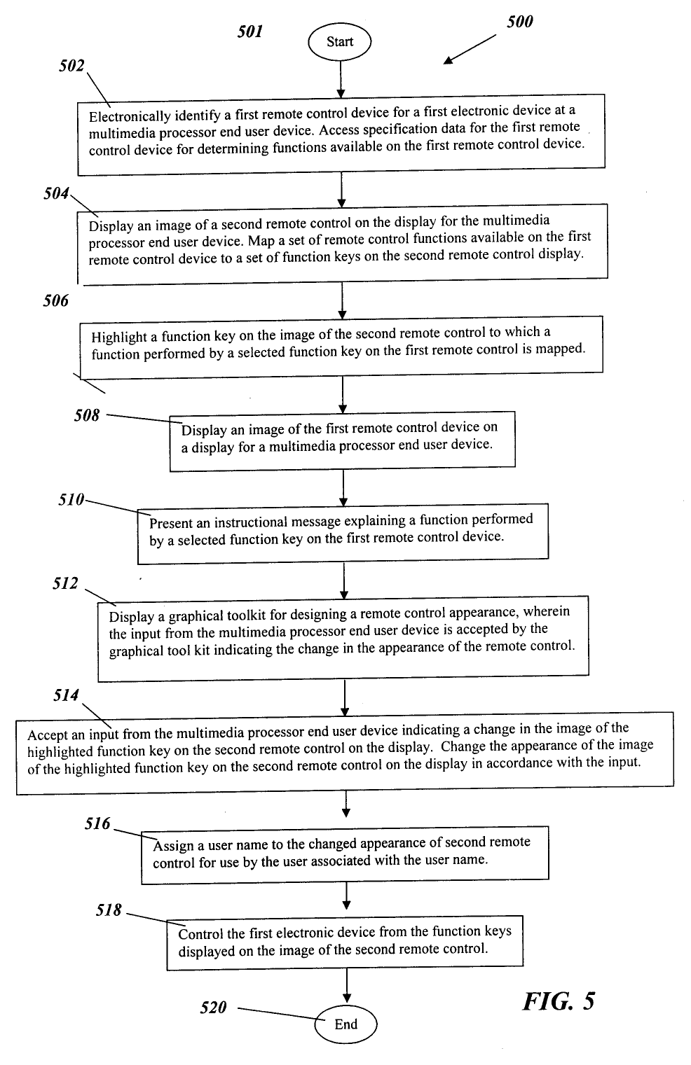

Turning now to FIG. 5, FIG. 5 depicts a flow chart of functions performed in a particular illustrative embodiment. No mandatory order or set of functions is dictated or implied by FIG. 5, as other embodiments may perform a different set of functions or perform functions in a different order. The flow chart starts at terminal 501 and proceeds to block 502 where an illustrative embodiment electronically identifies a first remote control device for a first electronic device at a multimedia processor end user device and accesses specification data for the first remote control device for determining functions available on the first remote control device.

A particular illustrative embodiment the proceeds to block 504 and displays an image of a second remote control on the display for the multimedia processor end user device and maps a set of remote control functions available on the first remote control device to a set of function keys on the second remote control display. A particular illustrative embodiment the proceeds to block 506 and highlights a function key on the image of the second remote control to which a function performed by a selected function key on the first remote control is mapped. A particular illustrative embodiment the proceeds to block 508 and displays an image of the first remote control device on a display for a multimedia processor end user device. A particular illustrative embodiment the proceeds to block 510 and presents an instructional message explaining a function performed by a selected function key on the first remote control device.

A particular illustrative embodiment the proceeds to block 512 and displays a graphical toolkit for designing a remote control appearance, wherein the input from the multimedia processor end user device is accepted by the graphical tool kit indicating the change in the appearance of the remote control. A particular illustrative embodiment the proceeds to block 514 to accept an input from the multimedia processor end user device indicating a change in the image of the highlighted function key on the second remote control on the display and change the appearance of the image of the highlighted function key on the second remote control on the display in accordance with the input. A particular illustrative embodiment the proceeds to block 516 and assigns a user name to the changed appearance of second remote control for use by the user associated with the user name. A particular illustrative embodiment the proceeds to block 518 and controls the first electronic device from the function keys displayed on the image of the second remote control. A particular illustrative embodiment ends the performance of functions shown in the flow chart at terminal 520.

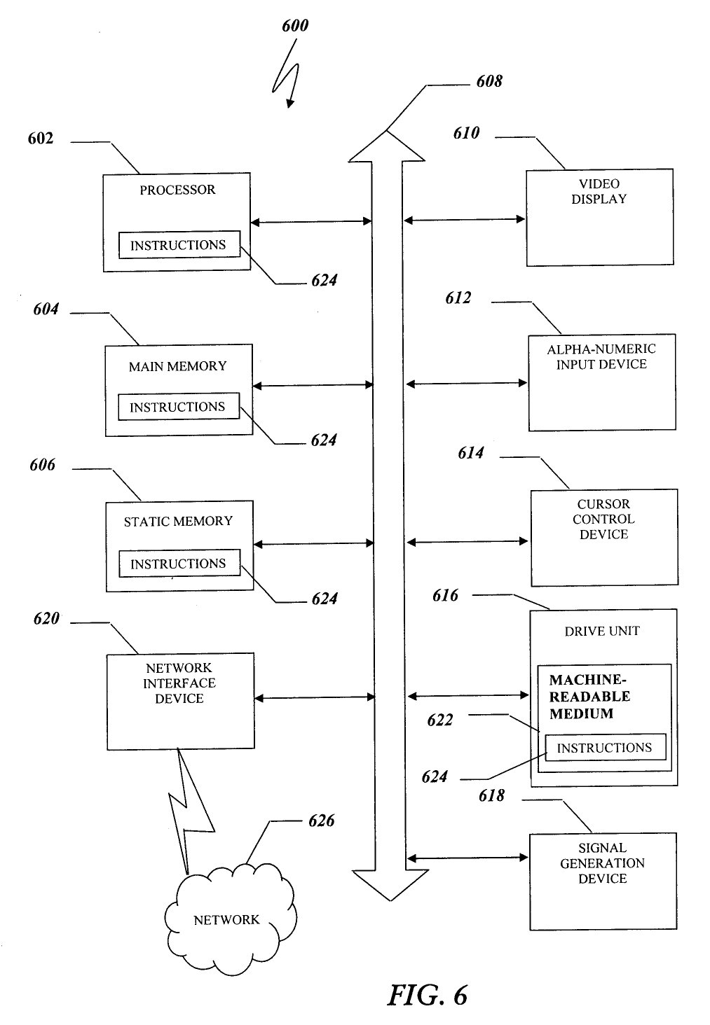

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 so that a device connected to a network environment 626 can send or receive voice, video or data, and to communicate over the network 626 using the instructions 624. The instructions 624 may further be transmitted or received over a network 626 via the network interface device 620. The machine readable medium may also contain a data structure for containing data useful in providing a functional relationship between the data and a machine or computer in an illustrative embodiment of the disclosed system and method.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computerized method for controlling an electronic device, the method comprising:
electronically identifying a first remote control device for a first electronic device at a multimedia processor end user device;
accessing specification data for the first remote control device for determining functions available on the first remote control device;
displaying an image of a second remote control on a display for the multimedia processor end user device;
mapping a set of remote control functions available on the first remote control device to a set of function keys on the image of the second remote control display;
accepting input data indicating a selected function key on the first remote control; and
highlighting a function key on the image of the second remote control to which a function performed by a selected function key on the first remote control is mapped.

2. The method of claim 1, the method further comprising:
displaying an image of the first remote control device on the display for a multimedia processor end user device.

3. The method of claim 1, wherein the selected function key on the first remote control is selected by an act selected from the group consisting of detecting placement of a cursor over the selected function key on the image displayed of the first remote control device and detecting actuation of the selected function key on the first remote control device.

4. The method of claim 1, the method further comprising:
presenting an instructional message explaining a function performed by the selected function key on the first remote control device.

5. The method of claim 1, the method further comprising:
accepting input data from the multimedia processor end user device indicating a change in the image of the second remote control on the display; and
changing the image of the second remote control on the display in accordance with the input data indicating the change.

6. The method of claim 5, wherein the change in the image further comprises a change selected from the group consisting of a change in the appearance of a selected function key, a change in the operation and appearance of a selected function key and a change in the appearance of the image of the second remote control.

7. The method of claim 1, the method further comprising:
assigning a name to the changed image of the second remote control for storage access in the data base by end users.

8. The method of claim 5, the method further comprising:
displaying a graphical toolkit for designing a remote control appearance, wherein the input from the multimedia processor end user device is accepted by the graphical tool kit indicating the change in the image of the second remote control.

9. The method of claim 5, wherein the graphical tool kit presents a plurality of appearances of function keys selected from the group consisting of slider bars, rotating radio knobs, joy sticks and push buttons, wherein each of the plurality of appearances operate differently from each other.

10. The method of claim 1, wherein the first remote control is identified by a camera and image recognition processor on the multimedia processor end user device.

11. The method of claim 1, wherein presenting the instruction message further comprises an act selected from the group consisting of audibly announcing the instructional message on a sound reproduction device in data communication with the multimedia processor end user device and announcing the instructional message on the display for the multimedia processor end user device.

12. The method of claim 1, the method further comprising:
controlling the first electronic device from the function keys displayed on the image of the second remote control.

13. A computer readable medium containing an embedded computer program for controlling an electronic device, the computer program comprising instructions to electronically identify a first remote control device for a first electronic device at a multimedia processor end user device; instructions to access specification data for the first remote control device for determining functions available on the first remote control device; instructions to display an image of a second remote control on a display for the multimedia processor end user device; instructions to map a set of remote control functions available on the first remote control device to a set of function keys on the image of the second remote control display; instructions to highlight a function key on the image of the second remote control to which a function performed by a selected function key on the first remote control is mapped; and instructions to display an image of the first remote control device on the display for the multimedia processor end user device.

14. The medium of claim 13, wherein the selected function key on the first remote control is selected by an act selected from the group consisting of detecting the presence of a cursor over the selected function key on the image displayed of the first remote control device and detecting an actuation of the selected function key on the first remote control device.

15. The medium of claim 13, the computer program further comprising instructions to accept input data from the multimedia processor end user device indicating a change in the image of the highlighted function key on the second remote control on the display; and instructions to change the appearance of the image of the highlighted function key on the second remote control on the display in accordance with the input.

16. The medium of claim 13, wherein the computer program further comprises instructions to accept data indicating a first remote control selection from a plurality of remote control devices displayed on the multimedia processor end user device display.

17. The medium of claim 13, the computer program further comprising instructions to control the first electronic device from the function keys displayed on the image of the second remote control.

18. A system for controlling an electronic device, the system comprising:
a computer readable medium;
a multimedia processor in data communication with the computer readable medium;
an identifying component to receive data to electronically identify a first remote control device for a first electronic device at a multimedia processor end user device;
a data base component to access specification data for the first remote control device for determining functions available on the first remote control device;
a display component for the multimedia processor to present an image of a second remote control;
a mapping component to assign a set of remote control functions available on the first remote control device to a set of function keys on the image of the second remote control; and
a highlight component to visually enhance a function key on the image of the second remote control to which a function performed by a selected function key on the first remote control is mapped.

19. The system of claim 18, the system further comprising an input component to receive data indicating a selected function key on the first remote control wherein the data is selected from the group consisting of data indicating detection of a cursor placement over the selected function key on the image displayed of the first remote control device and data indicating actuation of the selected function key on the first remote control device.

20. The system of claim 18, the system further comprising:
a presentation component to present an instructional message explaining a function performed by a selected function key on the first remote control device.

21. The system of claim 18, the system further comprising:
a graphical tool kit component to accept an input from the multimedia processor end user device indicating a change in the image of the highlighted function key on the second remote control on the display and change the appearance of the image of the highlighted function key on the second remote control on the display in accordance with the input.

22. The system of claim 18, the system further comprising a camera and image recognition processor on the multimedia processor end user device to identify the first remote control device at the multimedia processor end user device to access specifications for the first end user device.

23. The system of claim 18, the system further comprising:
an output component to send a control signal to the first electronic device corresponding to a selected function key displayed on the image of the second remote control.
